(19) United States
(12) Patent Application Publication
(10) Pub. No.: US 2019/0150660 A1
(43) Pub. Date: May 23, 2019

(54) OUTPUT DEVICE FOR A MILK FOAMING APPARATUS

(71) Applicant: JURA Elektroapparate AG, Niederbuchsiten (CH)

(72) Inventors: Philipp BUETTIKER, Oberbuchsiten (CH); Sandro KLEPZIG, Wangen bei Olten (CH)

(73) Assignee: JURA Elektroapparate AG, Niederbuchsiten (CH)

(21) Appl. No.: 16/301,793

(22) PCT Filed: May 18, 2017
(86) PCT No.: PCT/CH2017/000047

§ 371 Date: Nov. 15, 2018

(30) Foreign Application Priority Data
May 19, 2016 (EP) 16405008.0

(51) Int. Cl. A47J 31/44

(52) U.S. Cl. CPC A47J 31/4485

(57) ABSTRACT

The milk foaming apparatus output device includes an emulsifying chamber having a fluid inlet for a fluid containing milk, air and/or steam, which emulsifies into an emulsified milk foam liquid, and an output portion having an output opening and at least one output channel fluidly connected to the emulsifying chamber and the output opening so that the emulsified fluid flows through the output channel to the output opening. The output area also has a deflecting surface and/or at least one deflecting member for decelerating and swirling fluid in the emulsifying chamber. Also, a sieve element arrangement has at least one sieve element including passages arranged upstream of the output opening so that emulsified fluid from the emulsifying chamber to the output opening passes through the sieve element via at least one passage. The passages are arranged in a space extending annularly around the deflecting surface and/or the deflecting member.

The present invention pertains to an output device for a milk foaming apparatus.

Appliances for the preparation of hot beverages, particularly automatic coffee machines, frequently comprise an automatic or semi-automatic apparatus for preparing milk foam. The additionally required milk foam, particularly for the preparation of hot beverages such as Cappuccino or Latte Macchiato, can be produced and dispensed by means of such a milk foaming apparatus.

In this context, it is common practice that such a milk foaming apparatus draws in milk and, if applicable, air by utilizing the Venturi effect and emulsifies the milk and the air such that an emulsion of milk and air (milk foam) is formed. For example, hot steam can be introduced in a region of the milk foaming apparatus such that this steam flows past a milk inlet channel and in the process generates a vacuum, wherein milk is drawn in from a reservoir through a milk inlet channel and, if applicable, air is drawn in through an air inlet opening as a result of the vacuum.

Such milk foaming apparatuses comprise an emulsifying chamber and an output portion that is arranged downstream of the emulsifying chamber viewed in the flow direction of the milk to be foamed. A decelerating device for decelerating the fluid swirled in the emulsifying chamber is frequently provided, particularly in this output portion.

For example, DE 20 2006 009 786 U1 discloses a milk foaming apparatus that comprises a mixing chamber downstream of a steam supply pipe, wherein the mixing chamber is furthermore connected to a milk supply pipe and an air supply pipe or to a supply pipe for milk and air. When steam is introduced into the mixing chamber, air and milk are drawn into the mixing chamber in accordance with the Venturi principle and intermixed with steam therein so as to form a milk-air-steam mixture (milk foam). In order to improve the intermixing of milk, air and steam and to thereby bring about enhanced foaming of the milk-air-steam mixture, an emulsifying chamber with a deflecting plate arranged transverse to the flow direction may be provided downstream of the mixing chamber such that the milk-air-steam mixture flowing from the mixing chamber into the emulsifying chamber impinges on the deflecting plate. Inlet openings of multiple discharge channels are arranged in the deflecting plate such that the milk foam can reach its destination as unimpaired as possible. The inlet openings of the discharge channels are preferably grouped around the actual deflecting point, at which the milk-air-steam mixture flowing into the emulsifying chamber impinges on the deflecting plate. The discharge openings of the discharge channels are inclined relative to the cross-sectional plane of the discharge channels by a certain angle. In this way, an identical deflection of the milk-air-steam mixture flowing through the respective discharge channels takes place in all discharge channels such that milk foam propagates in the form of a defined (uniform) overall jet downstream of the discharge openings of the discharge channels.

However, larger air bubbles are formed again and again during milk foaming processes according to the Venturi principle. Milk foam containing relatively large air bubbles is usually perceived as unattractive by consumers. Furthermore, milk foam containing relatively large air bubbles is typically not very creamy and therefore does not meet the expectations of many consumers with respect to its consistency.

In appliances that in fact comprise a milk foaming unit, but are not equipped with a separate hot water outlet, the respective milk foaming unit is frequently also used for dispensing hot water in that hot water is dispensed through the milk foaming unit. In the process, additional air may be drawn in such that no stable water jet can form. In addition, the water jet may be discharged from the milk foaming unit excessively fast such that water splashes are formed in the surroundings of the milk foaming unit.

The present invention is therefore based on the objective of disclosing an improved output device for a milk foaming apparatus, in which the milk foam is as homogenous and fine-pored as possible, wherein said output device also makes it possible to dispense hot water in such a way that a formation of water splashes in the surroundings of the output device is largely prevented.

This objective is attained by means of an output device for a milk foaming apparatus with the characteristics of independent claim 1.

The output device for a milk foaming apparatus comprises an emulsifying chamber with a fluid inlet for introducing a fluid containing milk, air and/or steam into the emulsifying chamber, wherein said fluid emulsifies in the emulsifying chamber so as to form an emulsified fluid in the form of milk foam, as well as an output portion with an output opening for dispensing the emulsified fluid from the emulsifying chamber, wherein said output portion comprises at least one output channel that is fluidically connected to the emulsifying chamber and the output opening such that the emulsified fluid is enabled to flow from the emulsifying chamber to the output opening through the at least one output channel. In addition, a deflecting surface and/or at least one deflecting member for decelerating and swirling the fluid introduced into the emulsifying chamber is arranged in the output portion.

According to the invention, a sieve element arrangement with at least one sieve element is provided, wherein said sieve element comprises multiple passages and is arranged upstream of the output opening such that the emulsified fluid flowing from the emulsifying chamber to the output opening has to pass through the at least one sieve element via at least one of the passages, and wherein a hydraulic diameter of the passages lies in the range between 0.1 and 1.5 mm and a length of the passages lies in the range between 0.1 and 1.5 mm. Furthermore, the passages of the at least one sieve element are arranged in a space that extends annularly around the deflecting surface and/or the at least one deflecting member.

A definition of the term “hydraulic diameter” is provided below.

In this context, “emulsified fluid in the form of milk foam” refers to an emulsion of milk and air, i.e. a spatially distributed mixture of milk drops and air bubbles. Accordingly, the emulsifying chamber of the output device is suitable for accommodating a fluid containing milk, air and/or steam (for example a milk-air-steam mixture or a milk-air-steam mixture), wherein an emulsion of milk and air (milk foam) is ultimately formed by intermixing or swirling the components of this fluid in the emulsifying chamber.

Since a deflecting surface and/or at least one deflecting member is arranged in the output portion and the passages of the at least one sieve element are arranged in a space that extends annularly around the deflecting surface and/or the at least one deflecting member, a fluid being introduced through the fluid inlet is typically decelerated on the deflecting surface and/or the deflecting member and swirled in the emulsifying chamber before the introduced fluid can flow through the sieve element via at least one of the passages and reach the output opening.

If the introduced fluid contains milk, air and/or steam, for example, the deceleration and swirling caused by the deflecting surface and/or the deflecting member promotes intermixing of the milk with air and/or steam and therefore the formation of an emulsion with a spatially distributed mixture of milk drops and air bubbles.

The deceleration of the introduced fluid in the emulsifying chamber also has the effect that the fluid flows through the passages of the sieve element and the output opening with a reduced flow velocity. Such a deceleration of the introduced fluid is also advantageous when the output device is used for dispensing hot water, i.e. when hot water forms the fluid introduced into the emulsifying chamber. If hot water is introduced into the emulsifying chamber, the swirling and deceleration of the introduced hot water on the deflecting surface and/or the deflecting member is a prerequisite for ensuring that the hot water reaches the output opening with a slow velocity in order to thereby largely prevent the formation of water splashes in the surroundings of the output opening.

Since the passages of the least one sieve element are arranged in a space that extends annularly around the deflecting surface and/or the at least one deflecting member, the deflecting surface or the deflecting member essentially distributes a fluid being introduced into the emulsifying chamber uniformly over all regions of the sieve element that surround the deflecting surface and/or the at least one deflecting member and, in particular, over all passages that annularly surround the deflecting surface and/or the at least one deflecting member.

The sieve element arrangement has the effect that an emulsion of milk and air, which is located in the emulsifying chamber, can only reach the output opening of the output portion via the at least one output channel if this emulsion passes through the at least one sieve element of the sieve element arrangement via one or more of the passages of the at least one sieve element. In other words, the emulsion likewise has to flow through one or more of passages of the at least one sieve element.

The at least one sieve element particularly has the effect that the sieve element influences an emulsion flowing through the at least one output channel with respect to its flow profile (i.e. with respect to the spatial distribution of the flow velocity). Since the emulsion passes through the sieve element via the passages, the emulsion cannot pass through the sieve element with a spatially constant flow velocity. Due to the arrangement of the passages in the at least one sieve element, the emulsion rather flows through the sieve element with a flow velocity that spatially varies (depending on the arrangement of the passages). The spatial variation of the flow velocity is typically realized in such a way that the flow velocity has the velocity gradient. Due to the arrangement of the passages in the at least one sieve element, the spatial variation of the flow velocity is typically realized in such a way that the flow velocity has a velocity gradient, which likewise varies as a function of the location, particularly in the passages or in the vicinity of the respective passages upstream and/or downstream of the at least one sieve element.

When an emulsion of milk and air flows through the at least one sieve element, the milk drops and air bubbles contained in the emulsion can be deformed as a result of the aforementioned velocity gradient of the flow velocity. In this case, the respective milk drops and air bubbles can (depending on the respective velocity gradient) be deformed so significantly that an individual milk drop is divided into two or more milk drops, which respectively have a smaller volume than the respective individual milk drop prior to its division into multiple milk drops, and an individual air bubble is accordingly divided into two or more air bubbles, which respectively have a smaller volume than the respective individual air bubble prior to its division into multiple air bubbles.

It is preferred that such a division of individual milk drops into multiple smaller milk drops and such a division of individual air bubbles into multiple smaller air bubbles respectively takes place in the regions of the emulsion, in which the velocity gradient of the flow velocity is essentially oriented parallel to the flow velocity. An “extensional flow” typically exists in regions of the emulsion, in which the flow velocity of the emulsion is realized in such a way that the velocity gradient of the flow velocity is essentially oriented parallel to the flow velocity. This extensional flow causes a significant extension of milk drops and air bubbles in the direction of the flow velocity (due to the velocity gradient of the flow velocity) such that they can be divided into smaller milk drops and smaller air bubbles in a particularly efficient manner. Such extensional flows particularly occur in each of the passages of the at least one sieve element, through which the emulsion flows, wherein these extensional flows typically are particularly pronounced along the central longitudinal axes of the passages. Accordingly, milk drops and air bubbles, which essentially flow through a passage in the “center” (referred to a cross section of the respective passage), can be significantly extended in the flow direction and, if applicable, divided into multiple smaller milk drops and air bubbles.

The degree, to which milk drops and air bubbles of the emulsion can be respectively divided into smaller milk drops and smaller air bubbles while flowing through the passages of the at least one sieve element, is dependent on the spatial dimensions of the respective passages. It is proposed to realize the passages of the at least one sieve element in such a way that the passages respectively have a hydraulic diameter in the range between 0.1 and 1.5 mm and a length in the range between 0.1 and 1.5 mm.

In this way, the sieve element advantageously has the effect that an emulsion of milk and air, which is formed in the emulsifying chamber and passes through the sieve element, can be dispensed from the output opening of the output device in the form of a milk foam that contains a very homogenously distributed mixture of particularly small milk drops and air bubbles and therefore forms a milk foam, which has uniform and extremely fine pores and does not contain any large air bubbles, such that this milk foam is perceived as very creamy and optically appealing by consumers.

The output device is also advantageous when hot water should be dispensed via the emulsifying chamber and the output opening. In this case, the sieve element has the effect that water, which flows from the emulsifying chamber to the output opening via the at least one output channel, is decelerated and uniformly distributed in the output channel—in addition to the deceleration caused by the deflecting surface and/or the deflecting member in the emulsifying chamber. A compact water jet is thereby produced in the output opening, wherein the formation of water splashes in the surroundings of the output opening is prevented.

In an embodiment of the output device, the deflecting surface and/or the at least one deflecting member is arranged in a central region of the output opening. This central arrangement of the deflecting surface and/or the at least one deflecting member allows a particularly uniform distribution of a fluid introduced into the emulsifying chamber by means of the passages formed in the at least one sieve element.

In this way, the sieve element advantageously has the effect that an emulsion of milk and air, which is formed in the emulsifying chamber and passes through the sieve element, can be dispensed from the output opening of the output device in the form of a milk foam that contains a very homogenously distributed mixture of milk drops and air bubbles and therefore forms a milk foam with uniform pores.

According to an embodiment of the output device, the at least one sieve element is arranged in such a way that it essentially extends transverse to the flow direction of the emulsified fluid in the output channel. In this case, the emulsified fluid is distributed over a plurality of passages in a particularly uniform manner, wherein the emulsified fluid passes through the sieve element in such a way that the emulsified fluid essentially flows through the output channel uniformly (referred to a cross-sectional area of the output channel).

Furthermore, the at least one sieve element may be arranged upstream of the output opening at a distance from the output opening. In this case, the emulsified fluid flowing from the emulsifying chamber to the output opening still has the flow through the output channel over a certain distance downstream of the sieve element before it reaches the output opening. In this way, the emulsified fluid flowing to the output opening is conveyed in the output channel over a certain distance after it has passed through the sieve element. This has the effect that the emulsified fluid propagates through the output opening in the form of a jet that is oriented in a predefined direction in a relatively stable manner such that lateral fluctuations of the jet are largely prevented.

The at least one sieve element may be arranged in the emulsifying chamber, for example, on a far end of the at least one output channel referred to the output opening or in the at least one output channel.

The properties of the emulsified fluid (milk foam) being dispensed from the output opening can be advantageously influenced and therefore optimized with a suitable design of the passages of the at least one sieve element. Particularly the number of passages, the arrangement of the passages and the geometric dimensions of the passages can be suitably chosen.

For example, the passages of the at least one sieve element may with respect to a cross section of the respective passages be realized in such a way that the hydraulic diameter of the passages preferably lies in the range between 0.1 and 1.0 mm, particularly in the range between 0.3 and 0.9 mm. Furthermore, the passages of the at least one sieve element may with respect to a length of the respective passages be realized in such a way that the length of the passages preferably lies in the range between 0.15 and 1.0 mm, particularly in the range between 0.15 and 0.9 mm. This choice of the dimensions of the passages is advantageous for ensuring that an acceptable quantity of emulsified fluid can on the one hand flow through the respective passages per time unit and that the milk drops and air bubbles contained in the emulsified fluid can on the other hand be effectively divided into smaller milk drops and air bubbles while they pass through one of the passages (due to the formation of extensional flows in the respective passages).

For example, the passages of the at least one sieve element may be realized in such a way that the ratio of the hydraulic diameter to the length of the passages is greater than 1:1.5, preferably greater than 1:1.25 and less than 4:1, particularly greater than 1:1.25 and less than 3:1. In this way, extensional flows are formed over a relatively large area of the respective passages, through which the emulsified fluid flows, wherein said extensional flows are suitable for effectively dividing the milk drops and air bubbles contained in the emulsified fluid into smaller milk drops and air bubbles while they pass through one of the passages.

The at least one sieve element may furthermore be realized in such a way that the number of passages amounts to at least 10, preferably 20 to 300, particularly 25 to 200, especially 30 to 160. Since the sieve element comprises a relatively large number of passages, it is possible to essentially arrange the passages in a uniformly distributed manner (referred to a surface of the sieve element). In this way, the emulsified fluid is after passing through the at least one sieve element very homogenous (referred to a cross section of the at least one output channel), particularly with respect to the size and the spatial distribution of the milk drops and air bubbles in the fluid flowing through the output channel.

The at least one sieve element may be realized, for example, in the form of a plate-shaped body that is provided with through-holes, wherein the through-holes form the respective passages. The sieve element may alternatively be realized in the form of a screen structure, e.g. in the form of a woven or braided structure of intersecting metal wires or fibers (preferably of plastic), wherein the passages are realized in a “mesh-shaped” manner, i.e. the passages are respectively formed between metal wires or fibers that are interconnected in a mesh-shaped manner. In this case, the passages can preferably (but not necessarily) be realized round or angular (e.g. triangular, quadrangular or polygonal).

For example, the at least one sieve element of the sieve element arrangement 70 may be a flat, planar body that extends along a plane (at least in a region, in which the passages are arranged). The sieve element may naturally have different shapes. For example, the respective sieve element may be realized in the form of a structure that is curved or arched or extends along the contour (or at least a region of the contour) of a cylinder, a cone, a truncated cone, a cube, a cuboid, a tetrahedron or the like at least in a region, in which the passages are arranged.

The passages of the at least one sieve element may furthermore be arranged in such a way that two adjacent passages are spaced apart from one another by a distance between 0.1 and 1.5 mm, preferably a distance between 0.1 and 1.0 mm, particularly a distance between 0.3 and 0.9 mm. In this way, the passages are adjacently arranged relatively close to one another. Consequently, a relatively large quantity of emulsified fluid can flow through the respective passages per time unit and through the output channel—with essentially homogenous distribution over the cross section of the output channel.

In another embodiment of the output device, the sieve element arrangement comprises at least two (or more than two) sieve elements. In this case, the sieve elements are respectively arranged behind one another in the flow direction of the emulsified fluid such that the emulsified fluid respectively passes through the individual sieve elements of the sieve element arrangement successively (via the flow channels of the individual sieve elements of the sieve element arrangement).

In this case, the milk drops and air bubbles contained in the emulsified fluid are divided into smaller milk drops and air bubbles while they flow through the passages of the first sieve element of the sieve element arrangement, through which the emulsified fluid initially passes. Subsequently, these smaller milk drops and air bubbles can be once again deformed so significantly that they are divided into even smaller milk drops and air bubbles while they flow through the passages of the next sieve element, through which the emulsified fluid passes after flowing through the first sieve element. If the emulsified fluid flows through multiple sieve elements successively, a milk foam is formed, in which particularly small milk drops and air bubbles are very finely distributed and which therefore has particularly small pores.

A sieve element arrangement with at least two (or more than two) sieve elements is also advantageous when the output device is used for dispensing hot water, i.e. when hot water forms the fluid introduced into the emulsifying chamber. An arrangement of at least two (or more than two) sieve elements is a prerequisite for ensuring that the hot water can reach the output opening with a particularly slow velocity in order to thereby prevent the formation of water splashes in the surroundings of the output opening in a particularly effective manner.

It is preferred that two respective sieve elements of the sieve element arrangement, which are arranged behind one another in the flow direction of the emulsified fluid, are respectively spaced apart from one another by a certain distance in the flow direction of the emulsified fluid. This distance may lie, for example, in the range between 0.1 and 20 mm, preferably in the range between 0.5 and 10 mm, particularly in the range between 0.9 and 5 mm. In this way, an intermediate space is respectively formed between two sieve elements of the sieve element arrangement, which are arranged behind one another in the flow direction of the emulsified fluid, wherein the emulsified fluid, which in this space flows through one of the two sieve elements, is on the one hand thoroughly swirled in said intermediate space and on the other hand decelerated by the other of the two sieve elements in such a way that the flow of emulsified fluid can calm down in the intermediate space between the two sieve elements. This promotes a homogenization of the emulsified fluid in the intermediate space between the two sieve elements such that an emulsion with a particularly uniform spatial distribution of milk drops and air bubbles is formed.

In another embodiment of the output device, a deflecting surface and/or at least one deflecting member is arranged between the fluid inlet of the emulsifying chamber and the output opening in order to decelerate and swirl the fluid introduced into the emulsifying chamber. Such a decelerating and swirling effect is advantageous for forming an organoleptically optimal milk foam. The passages are preferably arranged in a space that extends annularly around the deflecting surface and/or the at least one deflecting member. In this case, the deflecting surface and/or the at least one deflecting member may be located, for example, in a central position in the output portion of the output device whereas the emulsified fluid can flow to the output opening past the deflecting surface or the deflecting member through a space that extends annularly around the deflecting surface and/or the at least one deflecting member.

According to another aspect of the invention, it is proposed that the emulsifying chamber comprises a first emulsifying chamber section, a second emulsifying chamber section and a connecting channel that forms a fluidic connection between the first emulsifying chamber section and the second emulsifying chamber section, wherein the first emulsifying chamber section borders on the fluid inlet and the at least one output channel leads into the emulsifying chamber in the region of the second emulsifying chamber section. In this case, a fluid introduced into the emulsifying chamber through the fluid inlet initially has to flow through the first emulsifying chamber section and then successively through the connecting channel and the second emulsifying chamber section. The connecting channel has—viewed in the flow direction of the fluid —a cross section that is smaller than the corresponding cross section of the first emulsifying chamber section and the second emulsifying chamber section.

This design of the emulsifying chamber has the effect that an emulsified fluid has to successively flow through the first emulsifying chamber section, the connecting channel and ultimately the second emulsifying chamber section before it reaches the output channel. In this case, an emulsified fluid of milk and air can flow through the emulsifying chamber in such a way that an extensional flow is formed in the connecting channel between the first emulsifying chamber section and the second emulsifying chamber section, wherein said extensional flow has the effect that milk drops and air bubbles contained in the emulsified fluid are divided into smaller milk drops and air bubbles while flowing through the connecting channel. In this way, the emulsion formed in the second emulsifying chamber section of the emulsifying chamber already contains relatively small milk drops and air bubbles before this emulsion passes through the at least one sieve element of the sieve element arrangement. When this emulsion subsequently flows through the at least one sieve element of the sieve element arrangement, the milk drops and air bubbles contained in the emulsion are once again divided into smaller milk drops and air bubbles as they pass through the at least one sieve element. Consequently, a milk foam, in which particularly small milk drops and air bubbles are very finely distributed and which therefore has particularly small pores, is also formed when the emulsified fluid initially flows into the second emulsifying chamber section of the emulsifying chamber through the connecting channel before it passes through the at least one sieve element. Even smaller milk drops and air bubbles can be achieved if the sieve element arrangement comprises at least two (or more than two) sieve elements—as described above—and the emulsion has to pass through all sieve elements of the sieve element arrangement in order to reach the output opening of the output device.

A milk foaming apparatus for foaming milk may comprise, for example, an output device of the above-described type and a device for introducing milk, air and/or steam into the emulsifying chamber of the output device.

A preferred embodiment of the inventive output device for a milk foaming apparatus, as well as a milk foaming apparatus equipped with an inventive output device, is described in greater detail below with reference to the drawings. In these drawings:

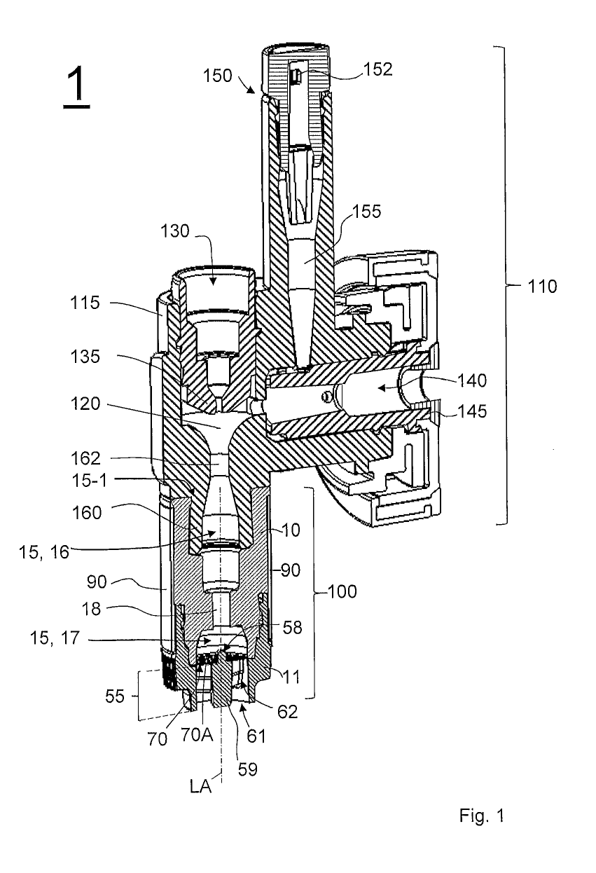

FIG. 1 shows a longitudinal section through a milk foaming apparatus with a first embodiment of the output device;

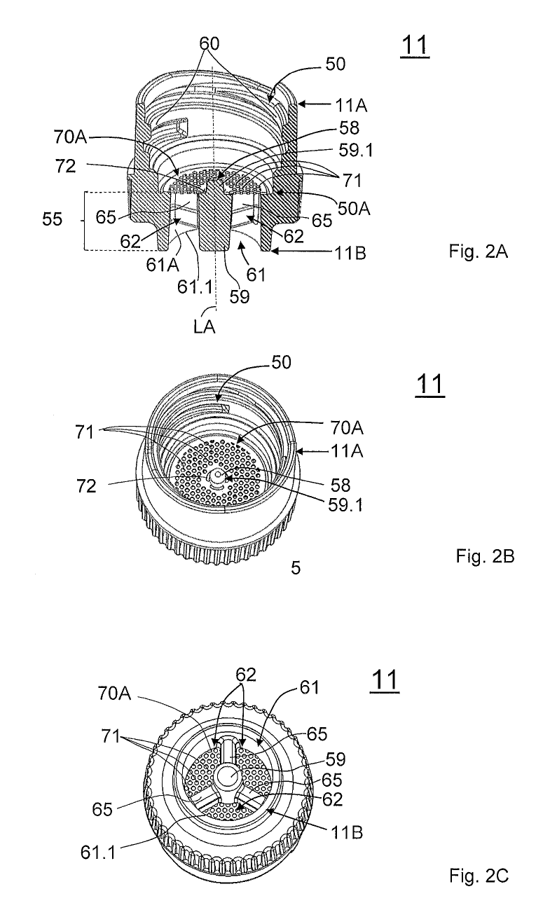

FIG. 2A shows a lower part of the output device according to FIG. 1 in the form of a longitudinal section;

FIG. 2B shows a top view of the lower part of the output device according to FIG. 2A;

FIG. 2C shows a bottom view of the lower part of the output device according to FIG. 2A;

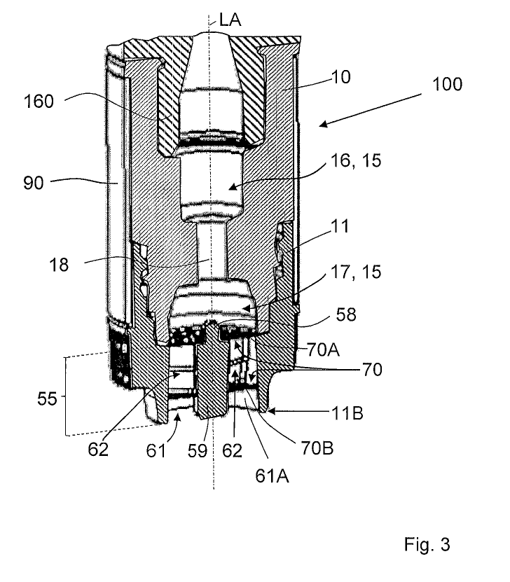

FIG. 3 shows a longitudinal section through a second embodiment of the output device;

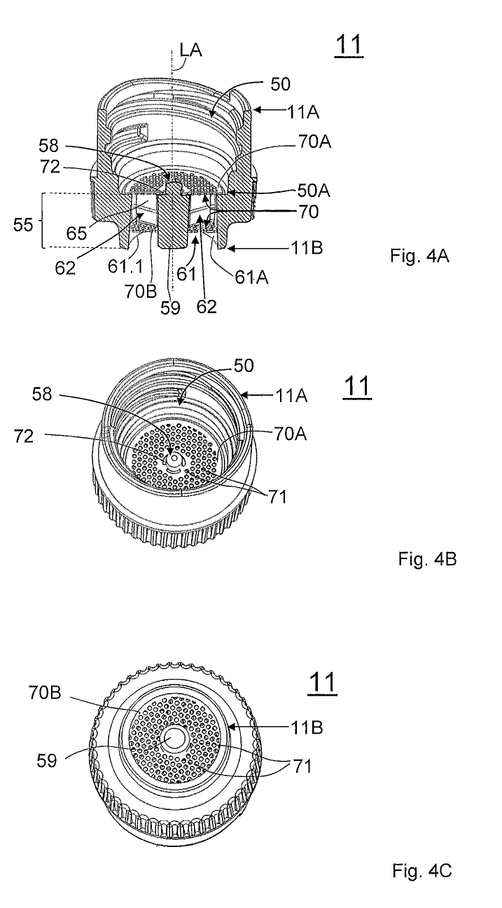

FIG. 4A shows a lower part of the output device according to FIG. 3 in the form of a longitudinal section;

FIG. 4B shows a top view of the lower part of the output device according to FIG. 4A;

FIG. 4C shows a bottom view of the lower part of the output device according to FIG. 4A;

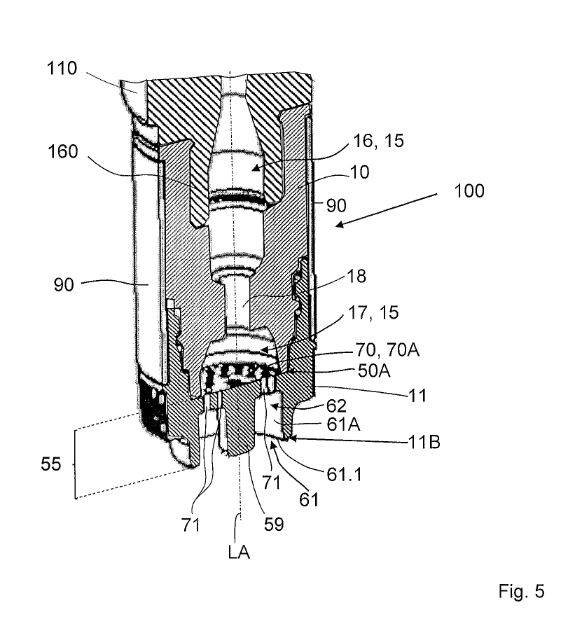

FIG. 5 shows a longitudinal section through a third embodiment of the output device;

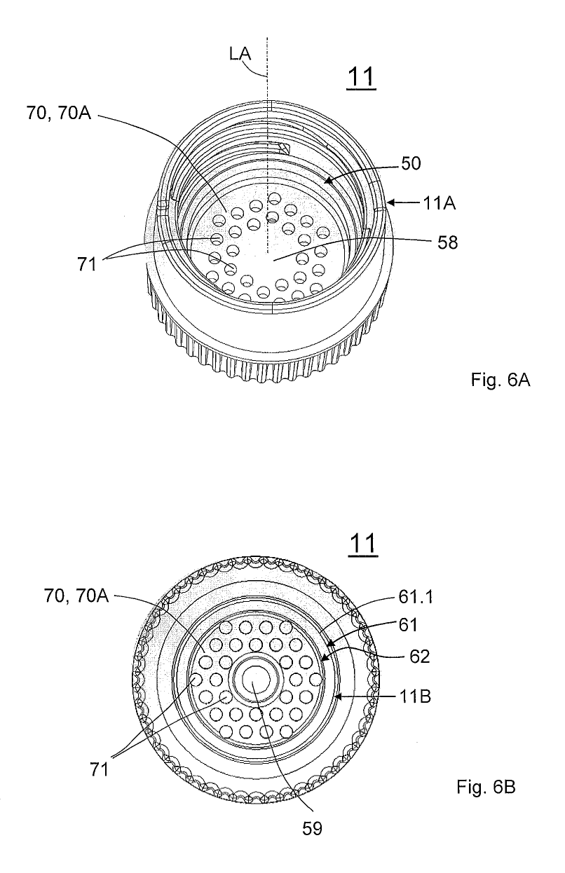

FIG. 6A shows a top view of the lower part of the output device according to FIG. 5;

FIG. 6B shows a bottom view of the lower part of the output device according to FIG. 5;

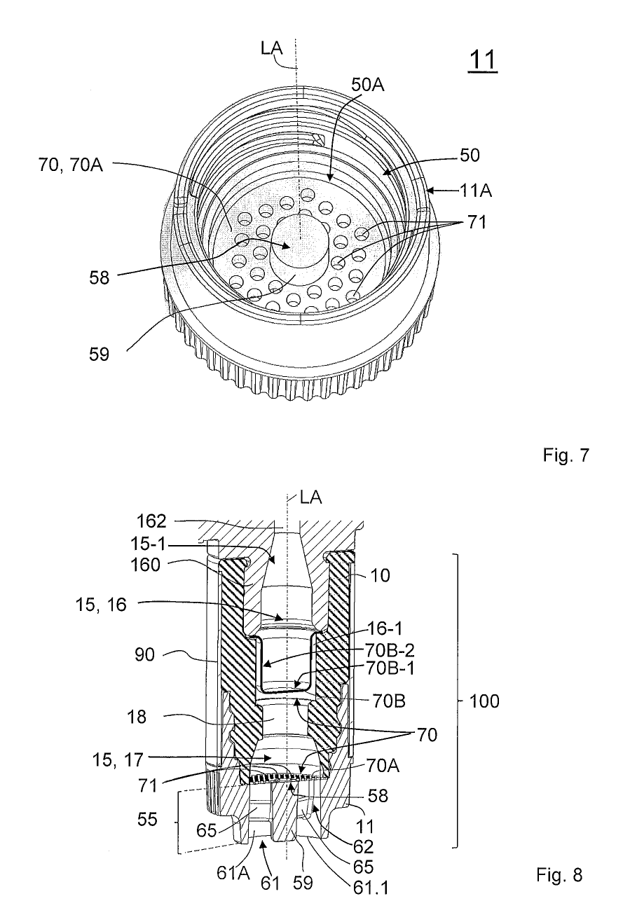

FIG. 7 shows a top view of another embodiment of a lower part of the output device; and

FIG. 8 shows a longitudinal section through a fourth embodiment of the output device.

FIG. 1 shows a milk foaming apparatus 1 that is equipped with an inventive output device. In the present example, the milk foaming apparatus 1 comprises an output device 100 with an emulsifying chamber 15 and a device 110 for introducing milk and air or, if applicable, milk, air and steam into the emulsifying chamber 15 of the output device 100.

According to FIG. 1, the device 110 comprises a housing 115, in which a hollow space 120 is formed, as well as an inlet 130 for supplying steam into the hollow space 120, an inlet 140 for supplying milk into the hollow space 120 and a device 150 for supplying air into the hollow space 120. The inlet 140 for supplying milk is provided with a connector 145 for a (not-shown) line, one end of which can be connected to the connector 145 and the other end of which can be connected to a (not-shown) milk reservoir in order to thereby realize the supply of milk from the milk reservoir to the inlet 140.

FIG. 1 also shows that the device 150 comprises an air channel 155, which extends in the interior of the housing 115 and is connected to the hollow space 120, as well as an inlet opening 152, by means of which the air channel 155 is connected to the atmosphere surrounding the milk foaming apparatus 1, such that air can be supplied into the hollow space 120 via the inlet opening 152 and the air channel 155.

FIG. 1 furthermore shows that the inlet 130 for supplying steam is realized in a steam nozzle 135, which protrudes into the hollow space 120, such that steam can be injected into the hollow space 120 through the inlet 130 via the steam nozzle 135. In order to produce a connection between the device 110 and the output device 100 with simple means, the device 110 is provided with a tubular connecting piece 160 that is connected to the hollow space 120 via a connecting channel 162.

According to FIG. 1, the emulsifying chamber 15 comprises a fluid inlet 15-1 on one side of the output device 100, wherein a fluid, for example in the form of a mixture of milk, air and steam, can be introduced into the emulsifying chamber 15 through said fluid inlet. The shape of the connecting piece 160 of the device 110 makes it possible to attach the output device 100 to the connecting piece 160 in such a way that a section of the output device 100, which borders on the fluid inlet 15-1, is positively seated on the connecting piece 160.

In order to produce milk foam with the milk foaming apparatus 1, the connector 145 of the inlet 140 can be connected to the milk reservoir via a line and the inlet 130 can be connected to a (not-shown) device for generating steam. When steam is injected into the hollow space 120 through the inlet 130 and the steam nozzle 135, a vacuum is generated in the hollow space 120 in accordance with the Venturi effect such that milk is drawn in through the inlet 140 and air is drawn in through the inlet opening 152 of the device 150 and the thusly drawn in milk and air can intermix with the injected steam in the hollow space 120. The thusly produced milk-air-steam mixture ultimately flows into the emulsifying chamber 15 through the connecting channel 162, wherein an emulsion in the form of milk foam is formed of the milk-air-steam mixture in said emulsifying chamber and can be discharged from the emulsifying chamber 15 through an output opening 61 on the lower end of the output device 100.

In the exemplary embodiment shown, the emulsifying chamber 15 preferably consists of a first emulsifying chamber section 16, a second emulsifying chamber section 17 and a connecting channel 18 that connects the emulsifying chamber sections 16, 17. The fluid inlet 15-1, the emulsifying chamber 15, the first emulsifying chamber section 16, the connecting channel 18 and the second emulsifying chamber section 17 are respectively arranged behind one another in series along a longitudinal axis LA of the output device 100. A fluid introduced into the emulsifying chamber 15 through the fluid inlet 15-1 therefore flows centrally through the emulsifying chamber 15 along the longitudinal axis LA of the output device 100.

The cross-sectional area of the connecting channel 18 (perpendicular to the longitudinal axis LA of the output device 100) is smaller than the cross-sectional area of the emulsifying chamber 15 in the first emulsifying chamber section 16 or in the second emulsifying chamber section 17 (in a respective cross section perpendicular to the longitudinal axis LA). The emulsifying chamber sections 16 and 17 therefore form two separate spaces in the emulsifying chamber 15, which are fluidically connected to one another by the connecting channel 18 only. The emulsifying chamber sections 16, 17 and the connecting channel 18 ensure intensive swirling of the introduced fluid (presently a milk-air-steam mixture) in both emulsifying chamber sections 16 and 17 and therefore bring about effective intermixing of all components of the fluid and, in particular, an emulsification of milk and air. It goes without saying that an emulsion of milk and air can also be formed with an emulsifying chamber 15, which consists of only a single space (that extends over the entire length of the emulsifying chamber 15).

A deflecting surface 58 is provided downstream of the fluid inlet 15-1 and extends transverse to the longitudinal axis LA of the output device 100 such that a fluid, which is introduced into the emulsifying chamber 15 and flows along the longitudinal axis LA, impinges on the deflecting surface 58 and is thereby decelerated and homogenized in the emulsifying chamber 15 in order to form a largely homogenous mixture of milk, air and steam in the emulsifying chamber 15. A deflecting member 59 may be provided in addition to the deflecting surface 58 as described in greater detail further below.

It should be noted that the device 110 may also be realized in such a way that the supply of air through the air channel 150 can be interrupted on demand. When steam is supplied through the inlet 130 in this case, a mixture of steam and milk only reaches the emulsifying chamber 15 and can be dispensed from the output device 100 in the form of heated (hot) milk. Milk could furthermore be conveyed into the emulsifying chamber 15 through the inlet 140 by means of a pump. In this case, it would be possible to convey (cold or optionally heated) milk into the emulsifying chamber 15 without having to generate a vacuum in the hollow space 120 based on the Venturi effect by introducing steam. It would accordingly be conceivable to completely eliminate a steam supply and to introduce a mixture of (cold or heated) milk and air only into the emulsifying chamber 15.

FIG. 1 furthermore shows that the output device 100 is in the present example composed of multiple parts: the output device 100 comprises at least two parts—a first (upper) part 10 and a second (lower) part 11—that can be assembled into a unit (as illustrated in FIG. 1) and separated from one another, for example, in order to thoroughly clean the parts 10 and 11 as needed. When the parts 10 and 11 are assembled into a unit according to FIG. 1, they may furthermore be arranged in a sleeve 90, which at least sectionally surrounds each of the parts 10 and 11 and is thereby suitable for holding together the parts 10 and 11 in such a way that the parts 10 and 11 can be once again removed from the sleeve 90 and separated from one another.

The parts 10 and 11 particularly comprise the emulsifying chamber 15 when they are assembled into a unit. In the present example, the first (upper) part is realized in such a way that it comprises the fluid inlet 15-1 of the emulsifying chamber 15 and, in particular, the first emulsifying chamber section 16 of the emulsifying chamber 15, the connecting channel 18 and at least part of the second emulsifying chamber section 17 of the emulsifying chamber 15 (which is connected to the first emulsifying chamber section 16 via the connecting channel 18). The second (lower) part 11, in contrast, is realized in such a way that it defines the second emulsifying chamber section 17 of the emulsifying chamber 15 on a lower end (when it is assembled with the first part 10 as illustrated in FIG. 1) and comprises an output portion 55 with an output opening 61 for dispensing emulsified fluid formed in the emulsifying chamber 15, wherein at least one output channel 62, which is connected to the second emulsifying chamber section 17 of the emulsifying chamber 15 with one of its ends and leads into the output opening 61 of the output portion 55 with its other end, is arranged in the output portion 55 such that emulsified fluid can flow from the emulsifying chamber 15 to the output opening 61 through the at least one output channel 62.

According to FIG. 1, the output device 100 has a sieve element arrangement 70 that in the present example comprises one sieve element 70A, wherein this sieve element 70A has multiple passages (that are not visible in FIG. 1, but illustrated at least in FIGS. 2A, 2B and 2C) and is arranged in the region of the at least one output channel 62 such that an emulsified fluid, which flows from the emulsifying chamber 15 to the output opening 61 through the at least one output channel 62, has to pass through the sieve element 70A via at least one of the passages.

The sieve element 70A according to FIG. 1 is in the present example arranged on the second (lower) part 11 of the output device 100 such that the sieve element 70A essentially extends perpendicular to the longitudinal axis LA of the output device 100. Details of the sieve element 70A and the second part 11 according to FIG. 1 can be gathered from FIGS. 2A-2C.

According to FIGS. 2A-2C, the second part 11 is realized in the form of an essentially cylindrical body that extends along the longitudinal axis LA and has a longitudinal section, which forms the output portion 55, on one end 11B. On its other end 11A that lies opposite of the end 11B, the second part 11 has a longitudinal section with a recess 50 that—starting from the end 11A—extends along the longitudinal axis LA and accordingly has a lower end 50A, which is spaced apart from the end 11A of the second part 11. In the present example, the output portion 55 is essentially identical to the longitudinal section of the second part 11, which extends from the end 11B of the second part 11 up to the end 50A of the recess 50.

An internal thread 60 is formed in the recess 50 as shown. This internal thread 60 makes it possible to screw the second part 11 on the first part 10 in order to thereby connect and attach the second part 11 to the first part 10 (as illustrated in FIG. 1), wherein it is implied that the second part has an external thread that corresponds (is complementary) to the internal thread 60. The recess 50 of the second part 11 borders directly on the output portion 55 and consequently forms part of the second emulsifying chamber section 17 of the emulsifying chamber 15 whenever the first part 10 and the second part 11 are assembled into a unit (as illustrated in FIG. 1). The end 50A of the recess 50 particularly forms a lower end of the second emulsifying chamber section 17 of the emulsifying chamber 15.

FIGS. 2A and 2C, in particular, show that the output opening 61 of the output portion 55 is realized on the end 11B of the second part 11, wherein its outer edge 61.1 has in the present example a circular shape. According to FIG. 2A, the output opening 61 is defined by the lower edge of a boundary surface 61A, which on the end 11B essentially extends cylindrically around the longitudinal axis LA and is essentially arranged rotationally symmetrical to the longitudinal axis LA.

The boundary surface 61A extends (starting from the end 11B of the second part 11) along the longitudinal axis LA up to the end 50A of the recess 50 and therefore borders on the second emulsifying chamber section 17 of the emulsifying chamber 15.

A deflecting member 59 is arranged in the center of the output opening 61 and extends—starting from the end 11B of the second part 11—along the longitudinal axis LA at a distance from the boundary surface 61A. Consequently, an annular intermediate space is formed between the deflecting member 59 and the boundary surface 61A, wherein said intermediate space is open toward the emulsifying chamber 15 and therefore forms a fluidic connection between the emulsifying chamber 15 and the output opening 61 such that a fluid can flow from the emulsifying chamber 15 to the output opening 61 through this intermediate space.

In the present example, the deflecting member 59 is connected to the boundary surface 61A by means of webs 65 such that the deflecting member 59 is respectively held in a fixed position relative to the boundary surface 61A and the output opening 61. Three webs 65 are provided in this case, wherein the webs 65 extend in the intermediate space between the deflecting member 59 and the boundary surface 61A radially referred to the longitudinal axis LA. The webs 65 therefore divide the intermediate space between the deflecting member 59 and the boundary surface 61A into three separate regions, each of which forms an output channel 62 that is connected to the emulsifying chamber 15 with one end and leads into the output opening 61 with the other end, i.e. a fluid located in the emulsifying chamber 15 can under these circumstances only flow to the output opening 61 through the output channels 62. In the present example, the output channels 62 are essentially identical in size and respectively have a cross section (perpendicular to the longitudinal axis LA) in the form of a circular ring segment.

FIGS. 1, 2A and 2B furthermore show that the deflecting member 59 comprises an (essentially) cylindrical section 59.1 on the far end referred to the output opening 61, wherein said cylindrical section extends along the longitudinal axis LA in such a way that it projects beyond the end 50A of the recess 50 and therefore protrudes into the second emulsifying chamber section 17 of the emulsifying chamber 15 over at least part of its length along the longitudinal axis LA. In the present example, an end face of the cylindrical section 59.1 forms the (aforementioned) deflecting surface 58, the function of which was already described above.

In the present example according to FIGS. 1 and 2A-2C, the sieve element 70A of the sieve element arrangement 70 is a separate component that can be inserted into the second part 11. The sieve element 70A according to FIGS. 1 and 2A-2C is realized in the form of a perforated plate that comprises a plurality of passages 71 and is furthermore shaped in such a way that it can be inserted into the recess 50 of the second part 11 along the longitudinal axis LA and positioned on the end 50A of the recess 50. In the present example, the sieve element 70A is realized in the form of a (preferably flat) annular plate with a central hole 72. In this case, the hole 72 is shaped in such a way that the cylindrical section 59.1 of the deflecting member 59 can pass through the central hole when the sieve element 70A is inserted into the recess 50 of the second part 11. In the arrangement according to FIGS. 1 and 2A-2C, the sieve element 70A is positioned on the end 50A of the recess 50 in such a way that it extends transverse to the longitudinal axis LA, wherein said sieve element is seated on the deflecting member 50 in such a way that the cylindrical section 59.1 protrudes through the central hole 72 over at least part of its length and therefore projects beyond the sieve element 70A into the second emulsifying chamber section 17 of the emulsifying chamber 15. In this case, the shape of the central hole can be adapted to the shape of the cylindrical section 59.1 in such a way that the sieve element 70A is held in a stable position when the sieve element 70A is inserted into the recess 50 of the second part 11 (as described above). In this position, the passages 71 extend essentially parallel to the longitudinal axis LA.

It should furthermore be noted that the cylindrical section 59.1 according to FIGS. 1 and 2A projects into the second emulsifying chamber section 17 of the emulsifying chamber 15 through the central hole 72 by such a distance that the deflecting surface 58 is (viewed in the direction of the longitudinal axis LA) spaced apart from the sieve element 70A. This arrangement of the deflecting surface 58 has the advantage that an emulsion of milk and air, which flows along the longitudinal axis LA in the direction of the deflecting member 59, is very intensively swirled when it impinges on the deflecting surface 58 in the second emulsifying chamber section 17 such that (as mentioned above) a particularly advantageous homogenization of the emulsion is achieved.

In the present example according to FIGS. 1 and 2A-2C, the sieve element 70A of the sieve element arrangement 70 is arranged on the far end of the output channels 62 referred to the output opening 61 and essentially extends perpendicular to the longitudinal axis LA in such a way that the sieve element 70A on the end 50A of the recess 50 completely covers the intermediate space between the boundary surface 61A and the deflecting member 59. A fluid flowing from the emulsifying chamber 15 to the output opening 61 therefore has to initially pass through the sieve element 70A via the passages 71 and subsequently flow through one or more of the output channels 62 in order to reach the output opening 61.

In the present example, the passages 71 have a circular cross section and longitudinally extend essentially parallel to one another and essentially perpendicular to the surface of the sieve element 70A (or parallel to the longitudinal axis LA according to FIGS. 1 and 2A). The diameter d of the passages 71 lies in the range between 0.1 and 1.5 mm and the length of the passages 71 lies in the range between 0.1 and 1.5 mm.

If an emulsified fluid in the form of milk foam flows from the emulsifying chamber 15 to the output opening under these circumstances, the emulsified fluid flows through the passages 71 in such a way that an extensional flow exists at least in certain regions of the flow in the passages 71, wherein said extensional flow is suitable for dividing the milk drops and air bubbles contained in the fluid into smaller milk drops and air bubbles such that the emulsified fluid is (as mentioned above) dispensed from the output opening 61 in the form of a milk foam with particularly small milk drops and air bubbles.

It should be noted that, in the context of the present invention, the cross-sectional area of the passages 71 does not necessarily have to be circular, but rather may have an arbitrary shape (e.g. round or with one or more angles).

The preceding specifications with respect to the diameter d of the passages 71 (if the passages 71 have the circular cross-sectional area) can be generalized for passages 71 with cross-sectional areas that deviate from a circular shape. In this context, the specification of a so-called “hydraulic diameter” may serve for characterizing the “size” of the cross section of a passage 71 with an arbitrarily shaped cross-sectional area.

The hydraulic diameter dₕ is a mathematical factor that can be used for calculating the pressure loss and throughput in pipes or channels if the cross section of the pipe or channel deviates from the circular shape. The use of the hydraulic diameter represents a good approximation for turbulent flows. The flow conditions for pipes and channels with circular cross section are extensively documented. In a flow channel with arbitrary cross section, the calculation of the hydraulic diameter serves for determining the inside diameter of the circular pipe, which at the same length and the same average flow velocity has the same pressure loss as the given flow channel. The definition of the hydraulic diameter is based on the idea that comparable conditions exist if the cross-sectional area A and the wetted perimeter U of the respective flow channels are proportional. With respect to the cross section of a flow channel, the term “wetted perimeter” respectively refers to the length of the curve, on which the fluid flowing through the flow channel contacts the wall of the flow channel. The hydraulic diameter dₕ is therefore defined by the formula:

$${d}_{h} = 4 \times \frac{A}{U}$$

In a flow channel that has a circular cross section with the diameter d, the hydraulic diameter therefore is dₕ=d. In a flow channel that has a square cross section with the side length a, the hydraulic diameter is dₕ=a.

Regardless of the cross-sectional shape of a passage 71, the hydraulic diameter dₕ and the length of the passages 71 therefore should be specifically realized in such a way that the hydraulic diameter dₕ of the passages 71 lies in the range between 0.1 and 1.5 mm and the length of the passages 71 lies in the range between 0.1 and 1.5 mm. As already mentioned above, other ranges (within the above-cited ranges) may also be specified for the hydraulic diameter dₕ and the length L of the passages 71 in order to thereby make it possible to optimize the milk foam being dispensed from the output device 100 with respect to its consistency.

For example, the passages of the at least one sieve element 70A may with respect to a cross section of the respective passages be realized in such a way that the hydraulic diameter dₕ of the passages 71 preferably lies in the range between 0.1 and 1.0 mm, particularly in the range between 0.3 and 0.9 mm. Furthermore, the passages of the at least one sieve element 70A may with respect to a length of the respective passages be realized in such a way that the length of the passages preferably lies in the range between 0.15 and 1.0 mm, particularly in the range between 0.15 and 0.9 mm. For example, the passages of the at least one sieve element 70A may be realized in such a way that the ratio of the hydraulic diameter dₕ to the length of the passages is greater than 1:1.5, preferably greater than 1:1.25 and less than 4:1, particularly greater than 1:1.25 and less than 3:1.

As already mentioned above, the sieve element 70A of the sieve element arrangement 70 in the example according to FIGS. 1 and 2A-2C is a separate component that can be inserted into the second part 11. This has the advantage that different materials can be used for the sieve element 70A and the second part 11 and different manufacturing methods can be used for respectively manufacturing the sieve element 70A and the second part 11. Consequently, the sieve element 70A and the second part 11 can be optimized independently of one another and, if applicable, in accordance with different criteria. It is furthermore possible to separate the sieve element 70A and the second part 11 from one another, for example, in order to clean the sieve element 70A independently of the second part 11 (and, if applicable, with cleaning agents that are not compatible with the material of the second part 11) or to replace the sieve element 70A with a corresponding new sieve element in case of a defect.

The second part 11 could consist, for example, of plastic and be manufactured with conventional and particularly inexpensive methods for manufacturing plastic components, e.g. by means of injection molding. The sieve element 70A, in contrast, could consist of a metallic material and be realized, for example, in the form of a (metallic) perforated plate. Such a perforated plate could be made of a metal sheet, which on the one hand has a small thickness and on the other hand a sufficiently high mechanical stability due to the use of a metallic material. In this case, the passages 71 can be produced with suitable methods for machining thin metal sheets, by means of which a corresponding metal sheet can be provided with a plurality of through-holes that respectively may have a small diameter (e.g. close to the above-specified lower limit for the hydraulic diameter dₕ of the passages 71) and also be arranged closely adjacent between two passages.

Alternatively, the sieve element 70A of the sieve element arrangement 70 in the example according to FIGS. 1 and 2A-2C may also be realized in the form of a screen structure, e.g. in the form of a woven or braided structure of intersecting metal wires or fibers (preferably of plastic), wherein the passages are realized in a “mesh-shaped” manner, i.e. they are respectively formed between metal wires or fibers that are interconnected in a mesh-shaped manner.

A second embodiment of the output device 100 is described below with reference to FIGS. 3 and 4A-4C. The second embodiment of the output device 100 and the embodiment of the output device 100 according to FIGS. 1 and 2A-2C have a number of common features. Accordingly, identical or identically acting components are respectively identified by the same reference symbols in FIGS. 1, 2A-2C, 3 and 4A-4C, wherein the preceding description of the embodiment of the output device 100 according to FIGS. 1 and 2A-2C can be applied analogously to the second embodiment of the output device 100 according to FIGS. 3 and 4A-4C.

The two embodiments of the output device 100 according to FIGS. 1 and 2A-2C and according to FIGS. 3 and 4A-4C essentially only differ with respect to constructive details of the sieve element arrangement 70.

The sieve element arrangement 70 of the output device 100 according to FIGS. 1 and 2A-2C only comprises a single sieve element 70A, but it is basically also possible that the sieve element arrangement 70 comprises two or more sieve elements. If the sieve element arrangement 70 comprises multiple sieve elements, they are preferably arranged behind one another in series such that emulsified fluid flowing to the output opening 61 has to successively pass through the individual sieve elements by flowing through the passages of several different sieve elements successively.

FIGS. 3 and 4A-4C show an example of a sieve element arrangement 70 that comprises two sieve elements 70A and 70B. According to this example, the sieve elements 70A and 70B respectively are separate components that have to be inserted into the second part 11 of the output device 100 and, if applicable, can be once again removed. With respect to its structure, the sieve element 70A according to FIGS. 3 and 4A-4C is identical to the sieve element 70A according to FIGS. 1 and 2A-2C. In the present example, the sieve element 70B essentially has the same structure as the sieve element 70A and accordingly is—like the sieve element 70A—realized in the form of a (preferably flat) annular plate with a central hole. The sieve element 70B is particularly shaped in such a way that it can be passed through the output opening 61 of the second part and positioned, for example, in the (above-described) intermediate space formed between the deflecting member 59 and the boundary surface 61A. The central hole of the sieve element 70B is dimensioned in such a way that the deflecting member 59 positively fits into this hole.

In the sieve element arrangement 70 according to FIGS. 3 and 4A-4C, the sieve elements 70A and 70B are positioned in such a way that they respectively extend essentially perpendicular to the longitudinal axis LA. In this case, the passages 71 of the sieve elements 70A and 70B extend essentially parallel to the longitudinal axis LA.

The sieve element 70A of the sieve element arrangement 70 according to FIGS. 3 and 4A-4C is arranged in the same way as the sieve element 70A of the sieve element arrangement 70 according to FIGS. 1 and 2A-2C, i.e. on the far ends of the output channels 62 referred to the output opening 61, such that the sieve element 70A on the end 50A of the recess 50 completely covers the intermediate space between the boundary surface 61A and the deflecting member 59. In this example, the sieve element 70B is positioned in the intermediate space, which (as mentioned above) is formed between the deflecting member 59 and the boundary surface 61A, such that the sieve elements 70A and 70B are spaced apart from one another in the direction of the longitudinal axis LA and therefore separated in the direction of the longitudinal axis LA by an intermediate space. In the present example, the sieve elements 70A and 70B are arranged on opposite sides of the webs 65 that connect the deflecting member 59 to the boundary surfaces 61A and separate the output channels 62 from one another. The distance between the sieve elements 70A and 70B is therefore at least identical to (or greater than) the dimension of the webs 65 in the direction of the longitudinal axis LA. This distance typically lies in the range between 0.1 and 20 mm, preferably in the range between 0.5 and 2.5 mm, particularly in the range between 0.9 and 1.2 mm.

Emulsified fluid flowing from the emulsifying chamber 15 to the output opening 61 through the output channels 62 essentially flows along the longitudinal axis LA and in the process passes through the sieve element 70A and the sieve element 70B successively via the respective passages 71 of the sieve element 70A and the sieve element 70B.

The milk drops and air bubbles contained in the emulsified fluid can be respectively divided into smaller milk drops and smaller air bubbles while they flow through the passages 71 of the sieve element 70A and while they subsequently flow through the passages 71 of the sieve element 70B (as a result of extensional flows forming in the passages 71 of the sieve elements 70A, 70B).

The intermediate space between the sieve elements 70A and 70B has the additional effect that the emulsified fluid flows through this intermediate space in the form of a turbulent flow, which is decelerated on the sieve element 70B, after it has passed through the sieve element 70A. This leads to swirling of the emulsified fluid in this intermediate space and to calming of the flow in this intermediate space such that the flow through the intermediate space between the sieve elements 70A and 70B improves the homogeneity of the spatial distribution of milk drops and air bubbles in the emulsified fluid.

A third embodiment of the output device 100 is described below with reference to FIGS. 5, 6A and 6B. The third embodiment of the output device 100 and the embodiment of the output device 100 according to FIGS. 1 and 2A-2C have a number of common features. Accordingly, identical or identically acting components are respectively identified by the same reference symbols in FIGS. 1, 2A-2C, 5, 6A and 6B, wherein the preceding description of the embodiment of the output device 100 according to FIGS. 1 and 2A-2C can be applied analogously to the third embodiment of the output device 100 according to FIGS. 5, 6A and 6B.

The output device 100 according to FIGS. 5, 6A and 6B comprises a sieve element arrangement 70 with a single sieve element 70A that is realized in the form of an integral component of the second part 11 of the output device 100, i.e. the sieve element arrangement 70 or the sieve element 70A and the second part 11 can be respectively manufactured in one piece. For example, the second part 11 and the sieve element arrangement 70 may consist of plastic in order to thereby realize an inexpensive manufacture, for example by means of an injection molding process.

The second part 11 according to FIGS. 5, 6A and 6B particularly has a one-piece output portion 55 that in the present example consists of a longitudinal section of the second part 11, which extends along the longitudinal axis LA between the end 11B of the second part 11 and the end 50A of the recess 50 of the second part 11 and particularly contains the output opening 61. The output portion 55 furthermore comprises a deflecting member 59 that is positioned in the center of the output opening 61 and extends—starting from the output opening 61—along the longitudinal axis LA at a distance from the boundary surface 61A such that an intermediate space, which essentially extends annularly around the longitudinal axis LA and the deflecting member 59, is formed between the deflecting member 59 and the boundary surface 61A. The sieve element 70A is respectively arranged on the far end of this intermediate space referred to the output opening and on the end 50A of the recess 50 of the second part 11, namely in the form of a section of the second part 11, which extends between the deflecting member 59 and the boundary surface 61A and rigidly connects the deflecting member 59 to the boundary surface 61, such that the deflecting member 59 is held in a stable position relative to the boundary surface 61A and the output opening 61.

In the present example, the deflecting member 59 is connected to the boundary surface 61A by means of the sieve element 70A in such a way that the deflecting member 59 and the sieve element 70A jointly form a plane boundary surface on the end 50A of the recess 50, wherein said plane boundary surface defines the recess 50 on its end 50A. In this case, a deflecting surface is formed by a central region of this boundary surface, which is arranged (essentially in the center or) on the longitudinal axis LA, wherein the surface of the sieve element 70A that faces the recess 50 extends annularly around the deflecting surface 58 and radially borders on the deflecting surface 58 flushly (without a step). Due to its arrangement, the deflecting surface 58 accordingly has the effect that emulsified fluid, which flows through the emulsifying chamber 15 along the longitudinal axis LA, impinges on the deflecting surface 58 and is therefore decelerated on the deflecting surface 58 and swirled in the emulsifying chamber.

The sieve element 70A comprises a plurality of passages 71 that essentially extend parallel to the longitudinal axis LA and have a circular cross-sectional area. The passages 71 are uniformly distributed around the deflecting surface 58 in a space, which respectively extends annularly around the deflecting surface 58 or the deflecting member 59, such that they lead into the intermediate space between the deflecting member 59 and the boundary surface 61A on an end that faces the output opening 61. This intermediate space is therefore fluidically connected to the emulsifying chamber 15, as well as to the output opening 61, and forms a (single) output channel 62, through which emulsified fluid can flow from the emulsifying chamber 15 to the output opening 61. This output channel 62 of the output device 100 according to FIGS. 5 and 6A-6B extends along the longitudinal axis LA in such a way that it surrounds the deflecting member 59 annularly in the region between the sieve element 70A and the output opening 61. In this way, it is ensured that the milk foam produced in the output device 100 is dispensed from the output opening 61 in the form of a jet that has a circular cross section and is homogenous over the entire area of its cross section.

Another embodiment of the output device 100 is described below with reference to FIG. 7. This embodiment and the output device 100 according to FIGS. 5, 6A and 6B differ with respect to constructive details that exclusively concern the second part 11. FIG. 7 therefore only shows the second part 11 according to this additional embodiment in the form of a perspective view that elucidates differences with respect to the output device 100 according to FIGS. 5, 6A and 6B.

In the present example according to FIG. 7, the deflecting member 59 is connected to the boundary surface 61A by means of the sieve element 70A in such a way that the deflecting member 59 and the sieve element 70A jointly form a boundary surface on the end 50A of the recess 50, wherein said boundary surface defines the recess 50 on its end 50A. In this case, the deflecting surface 58 is formed by a central region of this boundary surface, which is arranged (essentially in the center or) on the longitudinal axis LA, wherein said deflecting surface is in the present example realized on an end face of the deflecting member 59 that respectively faces the recess 50 (or faces away from the output opening 61).

The surface of the sieve element 70A, which faces the recess 50, respectively extends annularly around the deflecting surface 58 and the deflecting member 59. In contrast to the output device 100 according to FIGS. 5, 6A and 6B, however, the surface of the sieve element 70A, which faces the recess 50, does not radially border on the deflecting surface 58 without a step. The deflecting member 59 rather extends along the longitudinal axis LA in such a way that a longitudinal section of the deflecting member 59 projects beyond the sieve element 70A toward the end 11A of the second part 11 in the longitudinal direction LA (starting from the end 50A of the recess 50). In this case, the deflecting surface 58 is arranged at a distance from the surface of the sieve element 70A, which faces the recess 50, and particularly upstream of the sieve element 70A—referred to the flow direction of a fluid flowing from the fluid inlet 15-1 to the outlet opening 61. This design of the deflecting member has the effect that a fluid, which flows along the longitudinal axis LA in the direction of the output opening 61, is very intensively swirled in the vicinity of the deflecting member 59.

In the embodiments according to FIGS. 1-7, the respective sieve elements 70A and 70B of the sieve element arrangement 70 are typically flat, planar bodies, i.e. the sieve elements 70A and 70B respectively extend along a plane (at least in a region, in which the passages 71 are arranged), wherein opposite sides of the respective sieve element 70A or 70B are defined by planes that are arranged parallel to one another and the passages 71 preferably extend essentially perpendicular to these planes.

It should be noted that the invention is not limited to sieve elements that have the shape of a planar body. The respective sieve element should generally be shaped in such a way that it separates two opposing spaces from one another (at least in a region, in which the passages are arranged), wherein the passages form a fluidic connection between these two opposing spaces. Accordingly, the respective sieve element may be realized in the form of a structure that, for example, is curved or arched or extends along the contour (or at least a region of the contour) of a cylinder, a cone, a truncated cone, a cube, a cuboid, a tetrahedron or the like at least in a region, in which the passages are arranged.

An example of a sieve element arrangement, which contains at least one non-planar sieve element, is illustrated in FIG. 8. FIG. 8 shows an output device 100 that with respect to its structure essentially corresponds to the output devices 100 according to FIGS. 1 and 3. The output device 100 according to FIG. 8 comprises a sieve element arrangement 70 with two sieve elements, i.e. a sieve element 70A and a sieve element 70B. With respect to its structure, the sieve element 70A according to FIG. 8 is realized identical to the sieve element 70A according to FIGS. 1, 2a-2c and 3. The sieve element 70A according to FIG. 8 is therefore a flat, planar body with a plurality of passages 71. In the present example, the sieve element 70A according to FIG. 8 is furthermore arranged on the far end of the deflecting member 59 referred to the output opening 61 such that the sieve element 70A is seated on the deflecting member 59, wherein the sieve element furthermore extends essentially perpendicular to the longitudinal axis LA in such a way that the sieve element 70A completely covers the intermediate space between the boundary surface 61A and the deflecting member 59.

According to FIG. 8, the sieve element 70B is arranged in the emulsifying chamber 15 upstream of the sieve element 70A such that the sieve element 70B is spaced apart from the sieve element 70A. In the present example, the sieve element 70B is arranged in the region of the first emulsifying chamber section 16 of the emulsifying chamber 15 and extends over the entire cross section of the emulsifying chamber 15 transverse to the longitudinal axis LA such that a milk-air-steam mixture, which can optionally flow into the emulsifying chamber 15 through the connecting channel 162 and the fluid inlet 15-1, or an emulsion containing milk and air, which may be formed of the milk-air-steam mixture upstream of the sieve element 70B, initially has to pass through the sieve element 70B in order to reach the intermediate space between the sieve element 70B and the sieve element 70A.

In the present example according to FIG. 8, the sieve element 70B forms a container with a container wall, which in a region has a cylindrical shape (and comprises passages), i.e. a region of the sieve element 70B extends along the contour of a region of a cylinder (particularly along the curved surface area and an end face of the cylinder) and accordingly comprises a region 70B-1 that is realized in a planar manner and extends along an end face of the cylinder, as well as a region 70B-2 that is connected to the region 70B-1 and extends along the curved surface area of the cylinder. In the present example, the sieve element 70B is positioned and shaped in such a way that the region 70B-1 of the sieve element 70B extends essentially perpendicular to the longitudinal axis LA and the region 70B-2 of the sieve element 70B extends around the longitudinal axis LA at a distance from the longitudinal axis LA. For example, the regions 70B-1 and 70B-2 may be realized rotationally symmetrical referred to the longitudinal axis LA (as indicated in FIG. 8).

The sieve element 70B comprises a plurality of passages (not shown in FIG. 8), through which a milk-air-steam mixture or an emulsion containing milk and air can flow. Such passages may be formed in the region 70B-1 or in the region 70B-2 or in both regions 70B-1 and 70B-2, wherein passages formed in the region 70B-1 preferably extend essentially in the direction of the longitudinal axis LA and passages formed in the region 70B-2 essentially extend radially referred to the longitudinal axis LA. If passages are formed in the region 70B-2 of the sieve element 70B, the sieve element 70B is preferably shaped and arranged in the emulsifying chamber 15 in such a way that an intermediate space 16-1, which extends annularly around the region 70B-2 of the sieve element 70B, is formed between the region 70B-2 of the sieve element 70B and the surface of the upper part 10 of the output device 100 that defines the emulsifying chamber 15. In this way, it is ensured that a milk-air-steam mixture, which passes through the sieve element 70B via the passages formed in the region 70B-2, can flow to the sieve element 70A through the intermediate space 16-1 in the direction of the longitudinal axis LA.

In the present example according to FIG. 8, the sieve element 70B is spaced apart from the sieve element 70A by a distance that typically lies in the range between 0.1 and 20 mm. The intermediate space between the sieve elements 70A and 70B has the additional effect that the emulsified fluid flows through this intermediate space in the form of a turbulent flow, which is decelerated on the sieve element 70A, after it has passed through the sieve element 70B. This leads to swirling of the emulsified fluid in this intermediate space and to calming of the flow in this intermediate space such that the flow through the intermediate space between the sieve elements 70A and 70B improves the homogeneity of the spatial distribution of milk drops and air bubbles in the emulsified fluid.

1. An output device (100) for a milk foaming apparatus (1), wherein the output device comprises:
an emulsifying chamber (15) with a fluid inlet (15-1) for introducing a fluid containing milk, air and/or steam into the emulsifying chamber (15), wherein said fluid emulsifies in the emulsifying chamber (15) so as to form an emulsified fluid in the form of milk foam, and
an output portion (55) with an output opening (61) for dispensing the emulsified fluid from the emulsifying chamber (15), wherein said output portion (55) comprises at least one output channel (62) that is fluidically connected to the emulsifying chamber (15) and the output opening (61) such that the emulsified fluid is enabled to flow from the emulsifying chamber (15) to the output opening (61) through the at least one output channel (62),
wherein a deflecting surface (58) and/or at least one deflecting member (59) for decelerating and swirling the fluid introduced into the emulsifying chamber (15) is furthermore arranged in the output portion (55),
wherein
a sieve element arrangement (70) with at least one sieve element (70A, 70B) is provided, wherein said sieve element (70A, 70B) comprises multiple passages (71) and is arranged upstream of the output opening (61) such that emulsified fluid flowing from the emulsifying chamber (15) to the output opening (61) has to pass through the at least one sieve element (70A, 70B) via at least one of the passages (71), and wherein
a hydraulic diameter (dₕ) of the passages (71) lies in the range between 0.1 and 1.5 mm and a length of the passages (71) lies in the range between 0.1 and 1.5 mm,
wherein the passages (71) of the at least one sieve element (70A, 70B) are arranged in a space that extends annularly around the deflecting surface (58) and/or the at least one deflecting member (59).

2. The output device (100) according to claim 1, wherein the deflecting surface and/or the at least one deflecting member (59) is arranged in a central region of the output opening (61).

3. The output device (100) according to claim 1, wherein the ratio of the hydraulic diameter to the length of the passages (71) is greater than 1:1.5, preferably greater than 1:1.25 and less than 4:1, particularly greater than 1:1.25 and less than 3:1.

4. The output device (100) according to claim 1, wherein the at least one sieve element (70A, 70B) is arranged upstream of the output opening (61) at a distance from the output opening (61).

5. The output device (100) according to claim 1, wherein the at least one sieve element (70A, 70B) is realized planar or curved or arched or extends along the contour or at least a region of the contour of a cylinder, a cone, a truncated cone, a cube, a cuboid or a tetrahedron at least in a region, in which the passages (71) are arranged.

6. The output device (100) according to claim 1, wherein the number of passages (71) amounts to at least 10, preferably 20 to 300, particularly 25 to 200, especially 30 to 160.

7. The output device (100) according to claim 1, wherein the passages (71) are realized round, angular or in a mesh-shaped manner.

8. The output device (100) according to claim 1, wherein the passages (71) are arranged in such a way that two adjacent passages (71) are spaced apart from one another by a distance between 0.1 and 1.5 mm, preferably a distance between 0.1 and 1.0 mm, particularly a distance between 0.3 and 0.9 mm.

9. The output device (100) according to claim 1, wherein the at least one sieve element (70A) and the output portion (55) are realized in one piece.

10. The output device (100) according to claim 9, wherein the at least one sieve element (70A) is manufactured by means of an injection molding process.

11. The output device (100) according to claim 1, wherein the cross section of the at least one output channel (62) is essentially annular or has the shape of a circular ring segment.

12. The output device (100) according to claim 1, wherein the sieve element arrangement (70) comprises at least two sieve elements (70A, 70B).

13. The output device (100) according to claim 12, wherein the at least two sieve elements (70A, 70B) are arranged behind one another referred to the flow direction of the emulsified fluid and spaced apart from one another by a certain distance in the flow direction of the emulsified fluid, and wherein said distance lies in the range between 0.1 and 20 mm, preferably in the range between 0.5 and 10 mm, particularly in the range between 0.9 and 5 mm.

14. The output device (100) according to claim 1, wherein the at least one sieve element (70A, 70B) is arranged: in the emulsifying chamber (15) on a far end of the at least one output channel (62) referred to the output opening (61) or in the at least one output channel (62).

15. The output device (100) according to claim 1, wherein the emulsifying chamber (15) comprises a first emulsifying chamber section (16), a second emulsifying chamber section (17) and a connecting channel (18) that forms a fluidic connection between the first emulsifying chamber section (16) and the second emulsifying chamber section (17), and
wherein the first emulsifying chamber section (16) borders on the fluid inlet (15-1) and the at least one output channel (62) leads into the emulsifying chamber (15) in the region of the second emulsifying chamber section (17).

16. A milk foaming apparatus (1), comprising:
the output device (100) according to claim 1 and
a device (110) for introducing milk, air and/or steam into the emulsifying chamber (15) of the output device (100).
